(19) United States
(12) Patent Application Publication
(10) Pub. No.: US 2019/0268851 A1
(43) Pub. Date: Aug. 29, 2019

(54) CONTINUOUSLY UPDATED IOT-BASED ENERGY-SUPPLIER OPTIMIZATION

(71) Applicant: INTERNATIONAL BUSINESS MACHINES CORPORATION, Armonk, NY (US)

(72) Inventors: Bradley C. Herrin, Apex, NC (US); Jarett D. Stein, Bryn Mawr, PA (US); Xianjun Zhu, Cary, NC (US)

(21) Appl. No.: 15/907,791

(22) Filed: Feb. 28, 2018

(51) Int. Cl. H04W 52/02; H04L 29/08

(52) U.S. Cl. CPC H04W 52/0261; H04W 52/0251; H04W 4/70; H04L 67/16; H04L 67/125; H04W 52/0225

(57) ABSTRACT

An energy-usage management system continuously monitors energy usage of energy-consuming Internet of Things devices by streaming time-stamped usage data from sensors embedded into the devices. The system infers from the streamed data time-dependent usage patterns for each device. Further meaning is ascribed to these patterns by interpreting them in light of contextual information retrieved from external data sources. The system then predicts each device's future energy usage as a function of the previous-usage patterns and further refines those predictions to account for environmental changes that will occur if the energy consumer moves to a new location. The system computes total energy costs for the devices for each candidate energy supplier or service plan at the consumer's final location, selects an optimal candidate that offers the lowest cost, and automatically switches the devices' energy source to the optimal candidate.

### BACKGROUND

The present invention relates generally to managing distributed-resource usage of a home or business and in particular to using information provided by specialized sensor-equipped Internet of Things (IoT) devices to automatically stream data required to select an optimal resource supplier or service plan.

Current methods provide only crude methods of comparing carrier offerings and service plans for distributed resources like power, phone service, Internet connectivity, water, or television content. Direct comparisons are especially difficult when suppliers specify different pricing methods, which may include combinations of conventions like flat-rate pricing, unit-of-consumption pricing, tiered pricing that sets pricing as a function of a level of service, and time-dependent metering in which pricing varies as a function of a time of day, a day of the week, or a season of the year.

Furthermore, the benefits of a carrier's pricing and the performance or suitability of a carrier's service offering may be affected by a consumer's usage patterns. Time-dependent metering may, for example, be more beneficial for a consumer that has a higher proportion of usage during off-peak hours. Flat-rate pricing benefits those who consume the most quantities of a resource, and a tiered pricing structure may provide greater value for consumers who do not experience dramatic spikes or dips in usage.

Even if it were possible to address all these issues, selecting an optimal carrier or plan may also require knowledge of contextual information, such as differences in average energy usage or patterns of usage at different locations. A consumer's annual energy-usage pattern will change when a consumer moves from a hot climate to a colder part of the country. Similarly, if a business adds a major new client in a different time zone, that business's patterns of phone usage and computer-network may be subject to greater workday communications with that different time zone.

Extrinsic factors can also affect selection of an optimal carrier, service type, or service plan. An expectation that global oil prices will rise may, for example, make selection of a natural-gas energy supplier more attractive than selection of an oil energy supplier, even if the oil supplier currently offers lower prices. Similarly, differences in country, state, or local tariffs or regulations can complicate price comparisons when a consumer is planning to move to a new site.

There is no currently known way of accounting for all these considerations when determining whether a particular service plan is the lowest-priced option for a particular consumer or is one that provides that consumer with the cleanest, most effective, or otherwise most desirable type or level of service. Certain automated Web services attempt to crudely address this problem by listing the terms of pricing plans available at a consumer's location. Some may consider the consumer's past usage patterns, represented as monthly, quarterly, or yearly total-usage figures. But these Web services provide little more than first-order estimates of a supplier's or a plan's future cost, and cannot account for the more nuanced factors described above.

### SUMMARY

An embodiment of the present invention is a An energy-usage management system comprising a processor, a memory coupled to the processor, a computer-readable hardware storage device coupled to the processor, and a set of IoT sensors connected to the processor through the Internet, the storage device containing program code configured to be run by the processor via the memory to implement a method for continuously updated IoT-based energy-supplier optimization, the method comprising:

continuously collecting, by the system, energy-usage data of each device of a set of energy-consuming devices,

where the energy-consuming devices all consume energy supplied by a first energy supplier,

where a first sensor of the set of sensors is embedded into a first device of the set of energy-consuming devices,

where the first sensor is configured to continuously monitor energy usage of the first device,

where the first sensor represents the energy usage of the first device as a first sequence of time-stamped energy-usage levels, and

where the first sequence is continuously generated by the first sensor and is continuously streamed by the first sensor through the Internet to the processor;

identifying, by the system, a first time-varying pattern of energy consumption of the first device during a period of time ending at the time of the identifying;

predicting, by the system, one or more future time-varying patterns of energy usage of one or more devices of the set of energy-consuming devices; and

selecting from a set of candidate suppliers, by the system, an optimal energy supplier,

where the selecting is performed as a function of the one or more future time-varying patterns.

Another embodiment of the present invention is a method for continuously updated IoT-based energy-supplier optimization, the method comprising:

continuously collecting, by an energy-usage management system comprising a processor and a set of IoT sensors connected to the processor through the Internet, energy-usage data of each device of a set of energy-consuming devices,

where the energy-consuming devices all consume energy supplied by a same energy supplier,

where a first sensor of the set of IoT sensors is embedded into a first device of the set of energy-consuming devices,

where the first sensor is configured to continuously monitor energy usage of the first device,

where the first sensor represents the energy usage of the first device as a first sequence of time-stamped energy-usage levels, and

where the first sequence is continuously generated by the first sensor and is continuously streamed by the first sensor through the Internet to the processor;

identifying, by the system, a first time-varying pattern of energy consumption of the first device during a period of time ending at the time of the identifying;

predicting, by the system, one or more future time-varying patterns of energy usage of one or more devices of the set of energy-consuming devices; and

selecting from a set of candidate suppliers, by the system, an optimal energy supplier,

where the selecting is performed as a function of the one or more future time-varying patterns.

Yet another embodiment of the present invention is a computer program product, comprising a computer-readable hardware storage device having a computer-readable program code stored therein, the program code configured to be executed by an energy-usage management system comprising a processor, a memory coupled to the processor, and a computer-readable hardware storage device coupled to the processor, the storage device containing program code configured to be run by the processor via the memory to implement a method for continuously updated IoT-based energy-supplier optimization, the method comprising:

continuously collecting, by the system, energy-usage data of each device of a set of energy-consuming devices,

where the energy-consuming devices all consume energy supplied by a same energy supplier,

where a first sensor of the set of sensors is embedded into a first device of the set of energy-consuming devices,

where the first sensor is configured to continuously monitor energy usage of the first device,

where the first sensor represents the energy usage of the first device as a first sequence of time-stamped energy-usage levels, and

where the first sequence is continuously generated by the first sensor and is continuously streamed by the first sensor through the Internet to the processor;

identifying, by the system, a first time-varying pattern of energy consumption of the first device during a period of time ending at the time of the identifying;

predicting, by the system, one or more future time-varying patterns of energy usage of one or more devices of the set of energy-consuming devices; and

selecting from a set of candidate suppliers, by the system, an optimal energy supplier,

where the selecting is performed as a function of the one or more future time-varying patterns.

### BRIEF DESCRIPTION OF THE DRAWINGS

FIG. 1 depicts a cloud computing environment according to an embodiment of the present invention.

FIG. 2 depicts abstraction model layers according to an embodiment of the present invention.

FIG. 3 shows the structure of a computer system and computer program code that may be used to implement a method for continuously updated IoT-based energy-supplier optimization in accordance with embodiments of the present invention.

FIG. 4 shows a more detailed architecture of a computer system that may be used to implement a method for continuously updated IoT-based energy-supplier optimization.

FIG. 5 is a flow chart that illustrates steps of a method for continuously updated IoT-based energy-supplier optimization in accordance with embodiments of the present invention.

### DETAILED DESCRIPTION

Embodiments of the present invention improve upon current supplier-selection systems by incorporating Internet-of-Things (IoT) technology to provide real-time, device-specific resource-consumption data. The improved system may then use this streamed data to identify consumer-specific and device-specific usage patterns, from which the system may make meaningful, consumer-specific supplier comparisons, and then automatically reconfigure the consumer's resource source, carrier, source type, or billing plan to an optimal configuration.

It is to be understood that although this disclosure includes a detailed description on cloud computing, implementation of the teachings recited herein are not limited to a cloud computing environment. Rather, embodiments of the present invention are capable of being implemented in conjunction with any other type of computing environment now known or later developed.

Cloud computing is a model of service delivery for enabling convenient, on-demand network access to a shared pool of configurable computing resources (e.g., networks, network bandwidth, servers, processing, memory, storage, applications, virtual machines, and services) that can be rapidly provisioned and released with minimal management effort or interaction with a provider of the service. This cloud model may include at least five characteristics, at least three service models, and at least four deployment models.

Characteristics are as follows:

On-demand self-service: a cloud consumer can unilaterally provision computing capabilities, such as server time and network storage, as needed automatically without requiring human interaction with the service's provider.

Broad network access: capabilities are available over a network and accessed through standard mechanisms that promote use by heterogeneous thin or thick client platforms (e.g., mobile phones, laptops, and PDAs).

Resource pooling: the provider's computing resources are pooled to serve multiple consumers using a multi-tenant model, with different physical and virtual resources dynamically assigned and reassigned according to demand. There is a sense of location independence in that the consumer generally has no control or knowledge over the exact location of the provided resources but may be able to specify location at a higher level of abstraction (e.g., country, state, or datacenter).

Rapid elasticity: capabilities can be rapidly and elastically provisioned, in some cases automatically, to quickly scale out and rapidly released to quickly scale in. To the consumer, the capabilities available for provisioning often appear to be unlimited and can be purchased in any quantity at any time.

Measured service: cloud systems automatically control and optimize resource use by lever aging a metering capability at some level of abstraction appropriate to the type of service (e.g., storage, processing, bandwidth, and active user accounts). Resource usage can be monitored, controlled, and reported, providing transparency for both the provider and consumer of the utilized service.

Service Models are as follows:

Software as a Service (SaaS): the capability provided to the consumer is to use the provider's applications running on a cloud infrastructure. The applications are accessible from various client devices through a thin client interface such as a web browser (e.g., web-based e-mail). The consumer does not manage or control the underlying cloud infrastructure including network, servers, operating systems, storage, or even individual application capabilities, with the possible exception of limited user-specific application configuration settings.

Platform as a Service (PaaS): the capability provided to the consumer is to deploy onto the cloud infrastructure consumer-created or acquired applications created using programming languages and tools supported by the provider. The consumer does not manage or control the underlying cloud infrastructure including networks, servers, operating systems, or storage, but has control over the deployed applications and possibly application hosting environment configurations.

Infrastructure as a Service (IaaS): the capability provided to the consumer is to provision processing, storage, networks, and other fundamental computing resources where the consumer is able to deploy and run arbitrary software, which can include operating systems and applications. The consumer does not manage or control the underlying cloud infrastructure but has control over operating systems, storage, deployed applications, and possibly limited control of select networking components (e.g., host firewalls).

Deployment Models are as follows:

Private cloud: the cloud infrastructure is operated solely for an organization. It may be managed by the organization or a third party and may exist on-premises or off-premises.

Community cloud: the cloud infrastructure is shared by several organizations and supports a specific community that has shared concerns (e.g., mission, security requirements, policy, and compliance considerations). It may be managed by the organizations or a third party and may exist on-premises or off-premises.

Public cloud: the cloud infrastructure is made available to the general public or a large industry group and is owned by an organization selling cloud services.

Hybrid cloud: the cloud infrastructure is a composition of two or more clouds (private, community, or public) that remain unique entities but are bound together by standardized or proprietary technology that enables data and application portability (e.g., cloud bursting for load-balancing between clouds).

A cloud computing environment is service oriented with a focus on statelessness, low coupling, modularity, and semantic interoperability. At the heart of cloud computing is an infrastructure that includes a network of interconnected nodes.

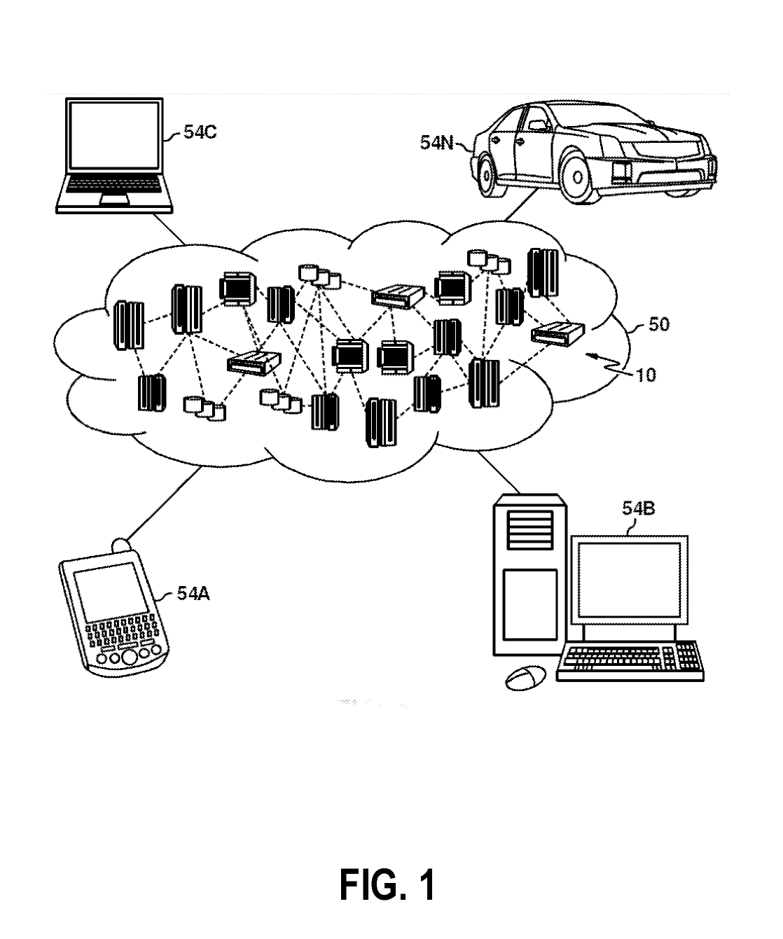

Referring now to FIG. 1, illustrative cloud computing environment 50 is depicted. As shown, cloud computing environment 50 includes one or more cloud computing nodes 10 with which local computing devices used by cloud consumers, such as, for example, personal digital assistant (PDA) or cellular telephone 54A, desktop computer 54B, laptop computer 54C, and/or automobile computer system 54N may communicate. Nodes 10 may communicate with one another. They may be grouped (not shown) physically or virtually, in one or more networks, such as Private, Community, Public, or Hybrid clouds as described hereinabove, or a combination thereof. This allows cloud computing environment 50 to offer infrastructure, platforms and/or software as services for which a cloud consumer does not need to maintain resources on a local computing device. It is understood that the types of computing devices 54A-N shown in FIG. 1 are intended to be illustrative only and that computing nodes 10 and cloud computing environment 50 can communicate with any type of computerized device over any type of network and/or network addressable connection (e.g., using a web browser).

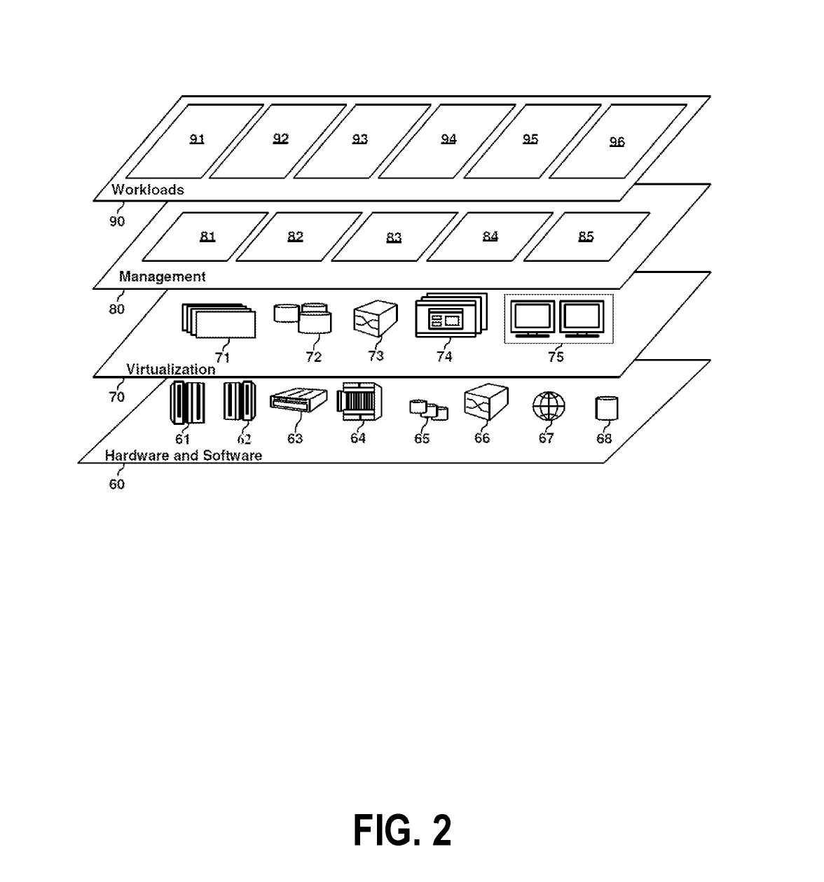

Referring now to FIG. 2, a set of functional abstraction layers provided by cloud computing environment 50 (FIG. 1) is shown. It should be understood in advance that the components, layers, and functions shown in FIG. 2 are intended to be illustrative only and embodiments of the invention are not limited thereto. As depicted, the following layers and corresponding functions are provided:

Hardware and software layer 60 includes hardware and software components. Examples of hardware components include: mainframes 61; RISC (Reduced Instruction Set Computer) architecture based servers 62; servers 63; blade servers 64; storage devices 65; and networks and networking components 66. In some embodiments, software components include network application server software 67 and database software 68.

Virtualization layer 70 provides an abstraction layer from which the following examples of virtual entities may be provided: virtual servers 71; virtual storage 72; virtual networks 73, including virtual private networks; virtual applications and operating systems 74; and virtual clients 75.

In one example, management layer 80 may provide the functions described below. Resource provisioning 81 provides dynamic procurement of computing resources and other resources that are utilized to perform tasks within the cloud computing environment. Metering and Pricing 82 provide cost tracking as resources are utilized within the cloud computing environment, and billing or invoicing for consumption of these resources. In one example, these resources may include application software licenses. Security provides identity verification for cloud consumers and tasks, as well as protection for data and other resources. User portal 83 provides access to the cloud computing environment for consumers and system administrators. Service level management 84 provides cloud computing resource allocation and management such that required service levels are met. Service Level Agreement (SLA) planning and fulfillment 85 provide pre-arrangement for, and procurement of, cloud computing resources for which a future requirement is anticipated in accordance with an SLA.

Workloads layer 90 provides examples of functionality for which the cloud computing environment may be utilized. Examples of workloads and functions which may be provided from this layer include: mapping and navigation 91; software development and lifecycle management 92; virtual classroom education delivery 93; data analytics processing 94; transaction processing 95; and IoT data-driven resource-supplier selection 96.

Aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module,” or “system.”

The present invention may be a system, a method, and/or a computer program product at any possible technical detail level of integration. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Smalltalk, C++, or the like, and procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the blocks may occur out of the order noted in the Figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

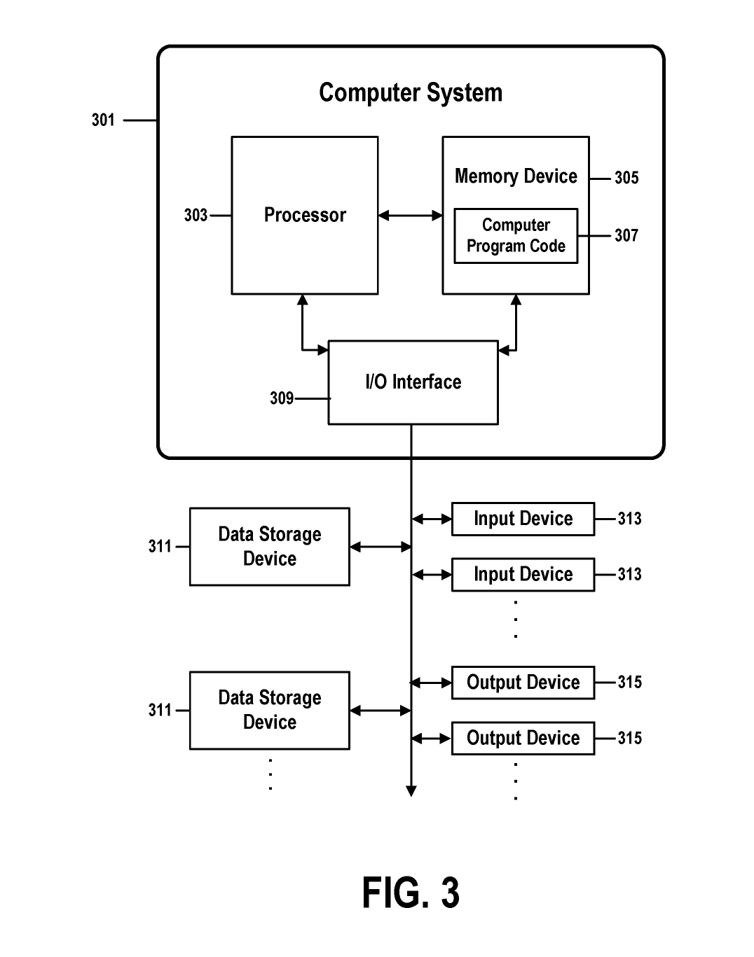

FIG. 3 shows a structure of a computer system and computer program code that may be used to implement a method for continuously updated IoT-based energy-supplier optimization in accordance with embodiments of the present invention. FIG. 3 refers to objects 301-315.

In FIG. 3, computer system 301 comprises a processor 303 coupled through one or more I/O Interfaces 309 to one or more hardware data storage devices 311 and one or more I/O devices 313 and 315.

Hardware data storage devices 311 may include, but are not limited to, magnetic tape drives, fixed or removable hard disks, optical discs, storage-equipped mobile devices, and solid-state random-access or read-only storage devices. I/O devices may comprise, but are not limited to: input devices 313, such as keyboards, scanners, handheld telecommunications devices, touch-sensitive displays, tablets, biometric readers, joysticks, trackballs, or computer mice; and output devices 315, which may comprise, but are not limited to printers, plotters, tablets, mobile telephones, displays, or sound-producing devices. Data storage devices 311, input devices 313, and output devices 315 may be located either locally or at remote sites from which they are connected to I/O Interface 309 through a network interface.

Processor 303 may also be connected to one or more memory devices 305, which may include, but are not limited to, Dynamic RAM (DRAM), Static RAM (SRAM), Programmable Read-Only Memory (PROM), Field-Programmable Gate Arrays (FPGA), Secure Digital memory cards, SIM cards, or other types of memory devices.

At least one memory device 305 contains stored computer program code 307, which is a computer program that comprises computer-executable instructions. The stored computer program code includes a program that implements a method for continuously updated IoT-based energy-supplier optimization in accordance with embodiments of the present invention, and may implement other embodiments described in this specification, including the methods illustrated in FIGS. 1-5. The data storage devices 311 may store the computer program code 307. Computer program code 307 stored in the storage devices 311 is configured to be executed by processor 303 via the memory devices 305. Processor 303 executes the stored computer program code 307.

In some embodiments, rather than being stored and accessed from a hard drive, optical disc or other writeable, rewriteable, or removable hardware data-storage device 311, stored computer program code 307 may be stored on a static, nonremovable, read-only storage medium such as a Read-Only Memory (ROM) device 305, or may be accessed by processor 303 directly from such a static, nonremovable, read-only medium 305. Similarly, in some embodiments, stored computer program code 307 may be stored as computer-readable firmware 305, or may be accessed by processor 303 directly from such firmware 305, rather than from a more dynamic or removable hardware data-storage device 311, such as a hard drive or optical disc.

Thus the present invention discloses a process for supporting computer infrastructure, integrating, hosting, maintaining, and deploying computer-readable code into the computer system 301, wherein the code in combination with the computer system 301 is capable of performing a method for continuously updated IoT-based energy-supplier optimization.

Any of the components of the present invention could be created, integrated, hosted, maintained, deployed, managed, serviced, supported, etc. by a service provider who offers to facilitate a method for continuously updated IoT-based energy-supplier optimization. Thus the present invention discloses a process for deploying or integrating computing infrastructure, comprising integrating computer-readable code into the computer system 301, wherein the code in combination with the computer system 301 is capable of performing a method for continuously updated IoT-based energy-supplier optimization.

One or more data storage units 311 (or one or more additional memory devices not shown in FIG. 3) may be used as a computer-readable hardware storage device having a computer-readable program embodied therein and/or having other data stored therein, wherein the computer-readable program comprises stored computer program code 307. Generally, a computer program product (or, alternatively, an article of manufacture) of computer system 301 may comprise the computer-readable hardware storage device.

In embodiments that comprise components of a networked computing infrastructure, a cloud-computing environment, a client-server architecture, or other types of distributed platforms, functionality of the present invention may be implemented solely on a client or user device, may be implemented solely on a remote server or as a service of a cloud-computing platform, or may be split between local and remote components.

While it is understood that program code 307 for a method for continuously updated IoT-based energy-supplier optimization may be deployed by manually loading the program code 307 directly into client, server, and proxy computers (not shown) by loading the program code 307 into a computer-readable storage medium (e.g., computer data storage device 311), program code 307 may also be automatically or semi-automatically deployed into computer system 301 by sending program code 307 to a central server (e.g., computer system 301) or to a group of central servers. Program code 307 may then be downloaded into client computers (not shown) that will execute program code 307.

Alternatively, program code 307 may be sent directly to the client computer via e-mail. Program code 307 may then either be detached to a directory on the client computer or loaded into a directory on the client computer by an e-mail option that selects a program that detaches program code 307 into the directory.

Another alternative is to send program code 307 directly to a directory on the client computer hard drive. If proxy servers are configured, the process selects the proxy server code, determines on which computers to place the proxy servers' code, transmits the proxy server code, and then installs the proxy server code on the proxy computer. Program code 307 is then transmitted to the proxy server and stored on the proxy server.

In one embodiment, program code 307 for a method for continuously updated IoT-based energy-supplier optimization is integrated into a client, server and network environment by providing for program code 307 to coexist with software applications (not shown), operating systems (not shown) and network operating systems software (not shown) and then installing program code 307 on the clients and servers in the environment where program code 307 will function.

The first step of the aforementioned integration of code included in program code 307 is to identify any software on the clients and servers, including the network operating system (not shown), where program code 307 will be deployed that are required by program code 307 or that work in conjunction with program code 307. This identified software includes the network operating system, where the network operating system comprises software that enhances a basic operating system by adding networking features. Next, the software applications and version numbers are identified and compared to a list of software applications and correct version numbers that have been tested to work with program code 307. A software application that is missing or that does not match a correct version number is upgraded to the correct version.

A program instruction that passes parameters from program code 307 to a software application is checked to ensure that the instruction's parameter list matches a parameter list required by the program code 307. Conversely, a parameter passed by the software application to program code 307 is checked to ensure that the parameter matches a parameter required by program code 307. The client and server operating systems, including the network operating systems, are identified and compared to a list of operating systems, version numbers, and network software programs that have been tested to work with program code 307. An operating system, version number, or network software program that does not match an entry of the list of tested operating systems and version numbers is upgraded to the listed level on the client computers and upgraded to the listed level on the server computers.

After ensuring that the software, where program code 307 is to be deployed, is at a correct version level that has been tested to work with program code 307, the integration is completed by installing program code 307 on the clients and servers.

Embodiments of the present invention may be implemented as a method performed by a processor of a computer system, as a computer program product, as a computer system, or as a processor-performed process or service for supporting computer infrastructure.

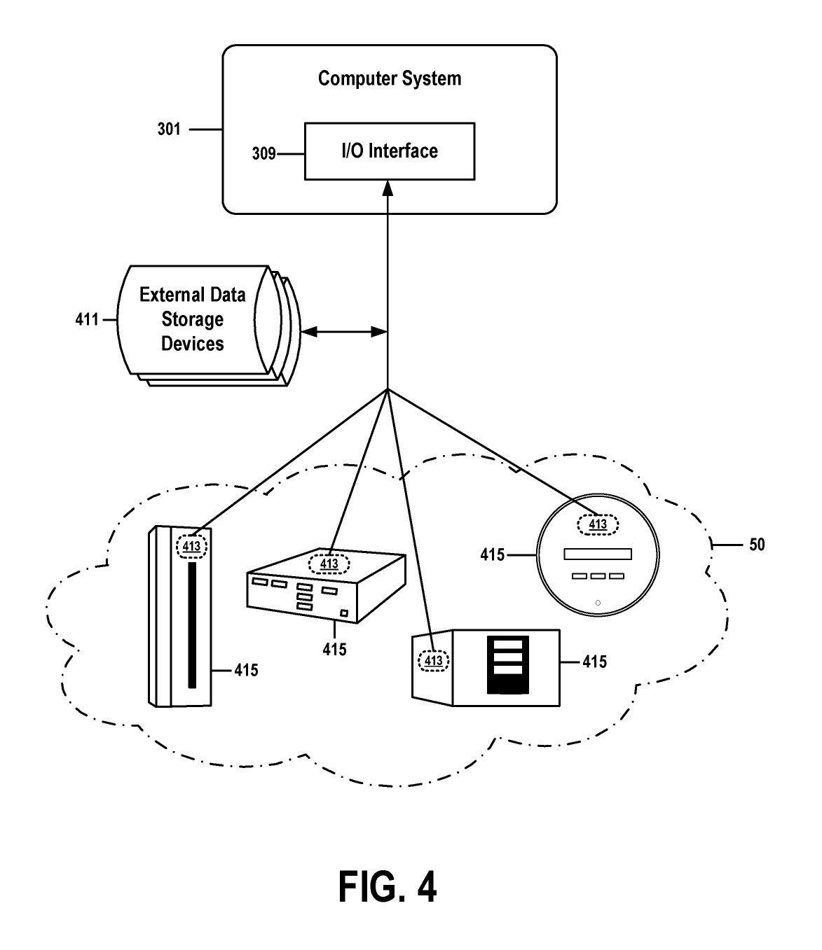

FIG. 4 shows a more detailed architecture of a computer system that may be used to implement a method for continuously updated IoT-based energy-supplier optimization. FIG. 4 shows objects 50, 301, 309, and 411-415.

Items 50, 301, and 309 are identical in form and function to similarly numbered items of FIG. 3.

In FIG. 4, computer system 301 receives continuous streams of data through I/O interface 309 from IoT sensors 413. Each sensor 413 is embedded into a corresponding IoT-enabled device 415 located in the Internet or other cloud-type computing environment 50.

Computer system 301 also communicates through I/O interface 309 with one or more external data repositories 411, from which computer system 301 may retrieve contextual information about a resource supplier, a resource consumer, a physical location of a resource supplier or consumer, or an extrinsic factor that may affect the past, present, or future cost of a resource to a consumer.

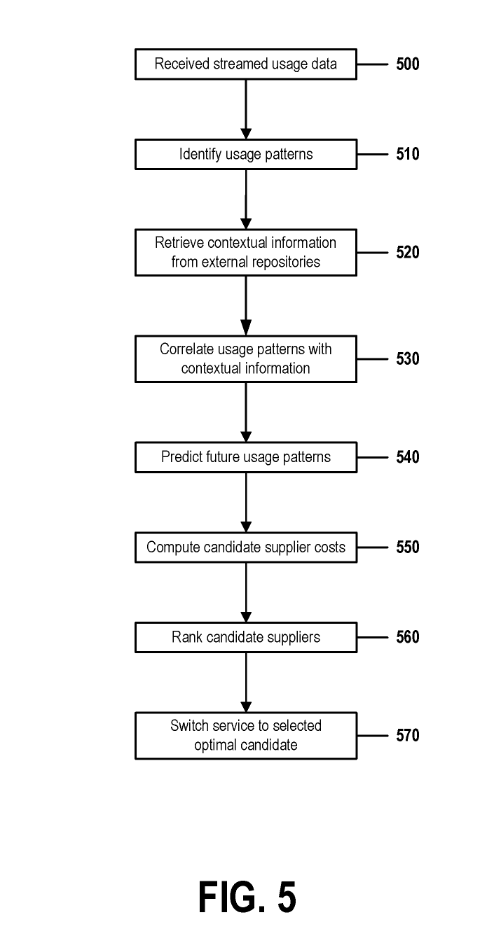

FIG. 5 is a flow chart that illustrates the steps of a method for continuously updated IoT-based energy-supplier optimization in accordance with embodiments of the present invention. FIG. 5 contains steps 500-570, which may be performed by embodiments that incorporate the architecture of FIGS. 1-4.

In step 500, processor 303 of an energy-usage management system similar to that shown in FIG. 3 receives a continuous stream of energy-usage data from each of a set of sensors 413 or other monitoring devices. Each sensor 413 is embedded into a corresponding Internet of Things (“IoT”) device 415 and is configured to monitor resource usage of its corresponding device 415. These sensors 413 each communicate with the processor 303 through the Internet or through an equivalent cloud network, intranet, or other computerized network.

For example, a specialized monitoring interface 413 embedded into an IoT coffeemaker, oven, or sound system 415 may send, through the Internet, a continuous stream of data to processor 303, where each element of the continuous stream comprises a time stamp and a level of energy consumption of device 415 at the time of the time stamp. Similarly, a flow sensor 413 embedded into a computerized IoT kitchen faucet 415 or into a “smart” plumbing fixture 415 may send, through a public network, a continuous stream of data to processor 303. In this case, each time-stamped data element of the data stream would identify an amount of water flowing through device 415 at the time of the time stamp. In yet another example, an integrated hardware/software module 413, comprising a metering application and wireless communications interface, might be embedded into a smartphone, tablet, computer system, desk telephone, router, or other data-consuming device 415. Here, the module 413 would continuously send a sequence of time-stamped data elements to processor 303, where each streamed element would identify an amount of data transmitted or received by device 415 at the time of the time-stamp. In other examples, the module 413 might track the durations of time and times of day during which device 415 performs certain activities, such as tethering a Bluetooth network, hosting a conference call, or downloading billable on-demand content.

In some embodiments, processor 303 may buffer and store the received data stream on one or more data storage devices 311. In other embodiments, processor 303 may buffer and cache received data streams in memory 305.

Each IoT sensor 413 will be configured to accommodate the particular device 415 into which the sensor 413 is embedded. Some sensors 413 may be configured to capture more than one sequences of data or to concurrently stream multiple streams of data. For example, a smart thermostat 415 may comprise several sensors 413. In this case, one of the sensors 413 might monitor energy usage of the thermostat itself and a second of the sensors 413 might receive flow data, which identifies oil usage of a smart furnace 415, from another sensor 413 that is embedded into the furnace 415 or that communicates with a sensor 413 embedded into the furnace 415. Similarly, a smart showerhead 415 into which is integrated a speaker system and an LED light may comprise a first embedded sensor 413 that monitors water flow and a second embedded sensor 413 that monitors electricity usage. Such a showerhead 415 might transmit two concurrent data streams, one of which continuously reports water usage and one of which continuously reports energy usage.

Processor 303 may receive many such data streams in parallel, each of which characterizes usage of one resource of one device 415. In some embodiments, the streamed data elements may be stored directly on a data storage device 311, where the elements may later be retrieved by the processor 303.

A sensor 413 may not be physically embedded into a device 415, so long as the physical configuration of the sensor 413 and device 415 provide the functionality described above. For example, a sensor 413 that monitors aggregate bandwidth usage of a subset of all bandwidth-consuming devices 415 that are connected to a particular WiFi network, that sensor may be physically embedded in a router or in a single port of a router, it may be a standalone device connected in series between the router and the monitored devices 415, or may be implemented as a set of complementary sensors physically embedded into or attached to the devices that are aggregated by a single sensor controller. Many other such topologies, as are known in the art, fall within the scope of the present invention.

In some embodiments, the sensors 413 may not continuously stream time-stamped data to processor 303. Sensors 413 may, for example, periodically transmit one or more time-stamped data elements to processor 303, may continuously stream unstamped data that is assigned a time stamp by processor 303 upon receipt, may send data asynchronously to processor 303 via a handshaking protocol, or may transmit data upon receiving a data request from processor 303. The present invention is flexible enough to accommodate many other communications methods known in the art, if desired by an implementer.

In step 510, the system analyzes each received data stream in order to identify time-varying usage patterns. Such patterns might, for example, reveal that an IoT self-operating vacuum cleaner used less electricity on weekends and during early evening hours, when its owners were more likely to shut it off. Other patterns might include: an overall increase in energy usage of air-conditioners during summer months; greater water usage of plumbing fixtures at certain times of day and during certain days of the week; increases in oil usage during winter months, during late-evening hours, and on certain days of the year; and greater water usage of a smart garden-watering device during the dry months of July and August.

In some embodiments, the system may infer from multiple usage patterns of individual devices 415 an aggregated pattern that characterizes resource usage of multiple devices 415. In one example, the system may identify a group of electrical devices, such as a television, a home-theater sound system, and several living-room light fixtures, that all consume greater amounts of electricity at the same time. Similarly, the system may identify three sets of complementary devices, such as a set of air-conditioning units, a set of air purifiers, and a set of room humidifiers, that almost never consume energy at the same time.

The system may also identify repeating patterns, such as increases in energy usage at certain times of day, or during certain days of the week, seasons of the year, or months of the year.

Many other types of patterns may be identified, using any mathematical, statistical, pattern-matching, or other means known in the art. In all cases, however, the patterns identified at this point should be based at least in part on the resource-usage figures streamed to the processor 303 from embedded sensors 413.

In step 520, the system retrieves contextual information from one or more external, public or private, repositories that identify factors capable of being correlated with the patterns identified in step 510. This contextual information may, for example, describe characteristics of a location at which the IoT devices 415 are located, weather or climatological conditions, dates of holidays or special events, or pricing trends.

In step 530, the system uses some or all of the retrieved contextual to impart further meaning to the resource-usage patterns identified in step 510. For example, the contextual information that identifies ambient temperatures at a particular location may be used to correlate outdoor temperature readings with otherwise-unexplained variations in a climate-control system 415′s energy usage. Weather and calendar data may similarly be used to correlate rises in resource consumption by certain devices 415 with large snowstorms, national holidays, and major sporting events; and to correlate drops in energy consumption with the occurrence of major blackouts.

In step 540, the system uses the refined resource-usage patterns inferred in steps 510 and 530 and the contextual information received in step 520 to predict future resource-usage patterns.

In some cases, this predicting may be as simple as extending identified patterns into the future. For example, if a weekly electricity-usage pattern of microwave oven 415 repeated with little variation over the course of twelve months, the system might in this step predict that a similar pattern will persist over the next twelve months. If the pattern varied on a dozen days during the last twelve months, and each of those dozen days was identified by contextual information to coincide with a national holiday or a major sporting event, the system might in this step predict that the device 415 will, during the coming year, continue to follow the previous year's weekly pattern, except for the days on which the same holidays and sporting events will occur.

The system may in this step use similar procedures to predict energy usage when it is known that the consumer's devices 415 will be moving to a different location. For example, contextual information that identifies average daily temperatures at multiple locations may be used to predict a certain percent increase or decrease in energy usage during days when average temperatures at a consumer's current location diverge most significantly from average temperatures at the consumer's planned future location.

The present invention is flexible enough to accommodate many other parameters that may vary when a consumer moves to a new location. For example, resource-usage patterns of lighting fixtures 415 may be affected by regional differences in time zones or lengths of day. Weather and climate can affect resource-consumption patterns of heating, cooling, humidifying, and dehumidifying devices, fans, cleaning appliances, cooking appliances, and many other types of devices 415.

At the conclusion of step 540, the system will have projected future resource usage patterns of each device 415, where these projected patterns are based on existing usage patterns of each device, interpreted in light of additional, contextual data comprising information about the devices 415, the environment of the devices 415, and time-dependent factors that may affect resource consumption of the devices 415.

In step 550, the system projects the future costs, from a set of candidate sources, of resource consumption as a function of the projected resource-consumption patterns identified instep 540. These cost projections may be tabulated as a function of contextual information retrieved in step 520 or retrieved by the system from other external sources.

In one example, if an electricity-consuming consumer plans to continue residing in Phoenix, Ariz., the system would in this step identify all candidate electricity sources available to residents of Phoenix. These sources may include three public-service utilities, a solar-panel leasing company, and a wind-power startup. In this example, the sources, the rates they charge, and their associated costs may be comprised by one or more extrinsic information sources. This information may include the rate plans of each utility, the average estimated leasing cost of solar panels capable of producing power sufficient to cover the consumer's projected energy needs, and the projected billings of the wind-power startup.

If, on the other hand, the electricity consumer plans to move from Phoenix to Seattle, Wash., the system may use a more elaborate procedure to predict the consumer's electricity costs in Seattle after the move. This prediction will be based on the consumer's future Seattle electricity-usage patterns derived in step 540, but will compute the future costs for a set of candidate electricity suppliers who supply the city of Seattle. In this case, those candidate suppliers might include a single public utility and three alternative-energy suppliers. As in the previous example, the system would in this case use contextual information, such as publicly available utility rate plans, to predict the consumer's future energy cost for each candidate supplier.

Some embodiments may further combine sources when appropriate. For example, if a public utility will buy back excess energy produced by a consumer's inhouse solar energy source, the system would compute the consumer's net energy cost in a two-supplier configuration, using the utility's most current published buy-back rates, the amount of energy likely to be produced by solar panels in the particular city, and the consumer's projected energy needs and usage patterns.

At the conclusion of step 550, the system will have derived the consumer's projected energy costs for each candidate supplier, service plan, and combination thereof that will be available to the consumer in the consumer's desired location.

In step 560, the system will rank the candidate suppliers in order of cost. In some embodiments, this ranking may be weighted by other considerations deemed significant by a consumer. A consumer may, for example, that prefers a cleaner type of energy source may configure the system to rank all solar, wind, and hydroelectric power sources above those suppliers whose energy is derived from fossil fuels. Similarly, a consumer that wishes to support the local economy of an oil-producing region may configure the system to assign a preference to suppliers of oil-based heating systems.

In some embodiments, the system will automatically select an optimal supplier in this step. In other embodiments, the system may require confirmation from a consumer of such a selection or may present to a consumer a list of top-ranked suppliers, allowing the consumer to subjectively select an optimal supplier.

In step 570, the system automatically switches service to the selected optimal supplier. In some cases, this switching will be scheduled to occur on a certain date, such as a date of a consumer's move to a new location. In some cases, the present service will be retained long enough to overlap with the new service, in order to accommodate a move.

In certain embodiments, the system, rather than automatically switching service itself, may instead direct downstream systems to automatically perform the switching, or may direct human operators to order the change in service.

Examples and embodiments of the present invention described in this document have been presented for illustrative purposes. They should not be construed to be exhaustive nor to limit embodiments of the present invention to the examples and embodiments described here. Many other modifications and variations of the present invention that do not depart from the scope and spirit of these examples and embodiments will be apparent to those possessed of ordinary skill in the art. The terminology used in this document was chosen to best explain the principles underlying these examples and embodiments, in order to illustrate practical applications and technical improvements of the present invention over known technologies and products, and to enable readers of ordinary skill in the art to better understand the examples and embodiments disclosed here.

What is claimed is:

1. An energy-usage management system comprising a processor, a memory coupled to the processor, a computer-readable hardware storage device coupled to the processor, and a set of IoT sensors connected to the processor through the Internet, the storage device containing program code configured to be run by the processor via the memory to implement a method for continuously updated IoT-based energy-supplier optimization, the method comprising:
continuously collecting, by the system, energy-usage data of each device of a set of energy-consuming devices,
where the energy-consuming devices all consume energy supplied by a same energy supplier,
where a first sensor of the set of sensors is embedded into a first device of the set of energy-consuming devices,
where the first sensor is configured to continuously monitor energy usage of the first device,
where the first sensor represents the energy usage of the first device as a first sequence of time-stamped energy-usage levels, and
where the first sequence is continuously generated by the first sensor and is continuously streamed by the first sensor through the Internet to the processor;
identifying, by the system, a first time-varying pattern of energy consumption of the first device during a period of time ending at the time of the identifying;
predicting, by the system, one or more future time-varying patterns of energy usage of one or more devices of the set of energy-consuming devices; and
selecting from a set of candidate suppliers, by the system, an optimal energy supplier,
where the selecting is performed as a function of the one or more future time-varying patterns.

2. The system of claim 1, further comprising:
automatically directing the optimal energy supplier, by the system, to begin supplying energy to the set of energy-consuming devices.

3. The system of claim 1, further comprising:
retrieving, by the system, from an external information source, first contextual information about a current location of the set of energy-consuming devices and second contextual information about a future location of the set of energy consuming devices,
where the predicting is performed as a function of at least one of the first contextual information and the second contextual information.

4. The system of claim 3, where the set of candidate suppliers is selected as a function of at least one of the first contextual information and the second contextual information.

5. The system of claim 3, where the first contextual information and the second contextual information are each selected from the group consisting of: an environmental characteristic of a geographical location; a characteristic of a population of a geographical location; a characteristic of an energy supplier's service plan; a measure of relative energy consumption of an energy-consuming device at a geographical location; a measure of a relative energy consumption of an energy consumer at a geographical location; and a discount of an energy supplier offered to energy consumers at a geographical location.

6. The system of claim 1, where the selecting further comprises choosing an optimal type of energy source.

7. The system of claim 6, where the optimal type of energy source offers a lowest cost for supplying energy capable of meeting total projected energy needs of the set of energy-consuming devices during a predetermined future period of time

8. The system of claim 1, where the selecting further comprises choosing an optimal service plan from the optimal energy supplier.

9. The system of claim 1, where the optimal energy supplier is a supplier of the set of candidate suppliers that offers a lowest cost for supplying energy capable of meeting total projected energy needs of the set of energy-consuming devices during a predetermined future period of time.

10. A method for continuously updated IoT-based energy-supplier optimization, the method comprising:
continuously collecting, by an energy-usage management system comprising a processor and a set of IoT sensors connected to the processor through the Internet, energy-usage data of each device of a set of energy-consuming devices,
where the energy-consuming devices all consume energy supplied by a same energy supplier,
where a first sensor of the set of IoT sensors is embedded into a first device of the set of energy-consuming devices,
where the first sensor is configured to continuously monitor energy usage of the first device,
where the first sensor represents the energy usage of the first device as a first sequence of time-stamped energy-usage levels, and
where the first sequence is continuously generated by the first sensor and is continuously streamed by the first sensor through the Internet to the processor;
identifying, by the system, a first time-varying pattern of energy consumption of the first device during a period of time ending at the time of the identifying;
predicting, by the system, one or more future time-varying patterns of energy usage of one or more devices of the set of energy-consuming devices; and
selecting from a set of candidate suppliers, by the system, an optimal energy supplier,
where the selecting is performed as a function of the one or more future time-varying patterns.

11. The method of claim 10, further comprising:
automatically directing the optimal energy supplier, by the system, to begin supplying energy to the set of energy-consuming devices.

12. The method of claim 10, further comprising:
retrieving, by the system, from an external information source, first contextual information about a current location of the set of energy-consuming devices and second contextual information about a future location of the set of energy consuming devices,
where the predicting is performed as a function of at least one of the first contextual information and the second contextual information.

13. The method of claim 10, where the selecting further comprises choosing an optimal service plan from the optimal energy supplier.

14. The method of claim 10, where the optimal energy supplier is a supplier of the set of candidate suppliers that offers a lowest cost for supplying energy capable of meeting total projected energy needs of the set of energy-consuming devices during a predetermined future period of time.

15. The method of claim 10, further comprising providing at least one support service for at least one of creating, integrating, hosting, maintaining, and deploying computer-readable program code in the computer system, wherein the computer-readable program code in combination with the computer system is configured to implement the collecting, the identifying, the predicting, and the selecting.

16. A computer program product, comprising a computer-readable hardware storage device having a computer-readable program code stored therein, the program code configured to be executed by an energy-usage management system comprising a processor, a memory coupled to the processor, and a computer-readable hardware storage device coupled to the processor, the storage device containing program code configured to be run by the processor via the memory to implement a method for continuously updated IoT-based energy-supplier optimization, the method comprising:
continuously collecting, by the system, energy-usage data of each device of a set of energy-consuming devices,
where the energy-consuming devices all consume energy supplied by a same energy supplier,
where a first sensor of the set of sensors is embedded into a first device of the set of energy-consuming devices,
where the first sensor is configured to continuously monitor energy usage of the first device,
where the first sensor represents the energy usage of the first device as a first sequence of time-stamped energy-usage levels, and
where the first sequence is continuously generated by the first sensor and is continuously streamed by the first sensor through the Internet to the processor;
identifying, by the system, a first time-varying pattern of energy consumption of the first device during a period of time ending at the time of the identifying;
predicting, by the system, one or more future time-varying patterns of energy usage of one or more devices of the set of energy-consuming devices; and
selecting from a set of candidate suppliers, by the system, an optimal energy supplier,
where the selecting is performed as a function of the one or more future time-varying patterns.

17. The computer program product of claim 16, further comprising:
automatically directing the optimal energy supplier, by the system, to begin supplying energy to the set of energy-consuming devices.

18. The computer program product of claim 16, further comprising:
retrieving, by the system, from an external information source, first contextual information about a current location of the set of energy-consuming devices and second contextual information about a future location of the set of energy consuming devices,
where the predicting is performed as a function of at least one of the first contextual information and the second contextual information.

19. The computer program product of claim 16, where the selecting further comprises choosing an optimal service plan from the optimal energy supplier.

20. The computer program product of claim 16, where the optimal energy supplier is a supplier of the set of candidate suppliers that offers a lowest cost for supplying energy capable of meeting total projected energy needs of the set of energy-consuming devices during a predetermined future period of time.
